(19) United States
(12) Patent Application Publication
(10) Pub. No.: US 2011/0056748 A1
(43) Pub. Date: Mar. 10, 2011

(54) WELLBORE FLUIDS CONTAINING SIZED CLAY MATERIAL AND METHODS OF USE THEREOF

(75) Inventors: Neale Browne, Houston, TX (US); Mukesh Kapila, The Woodlands, TX (US)

(73) Assignee: M-I L.L.C., Houston, TX (US)

(21) Appl. No.: 12/991,280

(22) PCT Filed: May 9, 2008
(86) PCT No.: PCT/US08/63160

§ 371 Date: Nov. 5, 2010

(51) Int. Cl. E21B 7/12; E21B 7/00; C09K 8/05

(52) U.S. Cl. 175/5; 175/57; 507/140

(57) ABSTRACT

A wellbore fluid that includes a base fluid; and a sized non-hydratable clay is disclosed. The base fluid may be a water-based fluid or an oil-based fluid. Methods of drilling with such wellbore fluids that contain a base fluid and a sized non-hydratable clay are also disclosed.

### BACKGROUND OF INVENTION

1. Field of the Invention

Embodiments disclosed herein relate generally to wellbore fluids having clay materials therein. In particular embodiments disclosed herein relate generally to wellbore fluids containing size clay material and methods of use thereof.

2. Background Art

When drilling or completing wells in earth formations, various fluids typically are used in the well for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

One of the above-mentioned purposes includes the transportions of cuttings up to the earth's surface in addition to prevention of the settling of drill cuttings and weight material to the low-side or the bottom of the hole during periods of suspended drilling operations. This phenomenon of preventing the settling of solids within a wellbore fluid is due to the fluid's thixotropic properties. One of ordinary skill in the art should appreciate that without such thixotropic properties, the settling of solids within the fluid may result in the deposition of solids on the drill bit which may become “stuck” or, a reduction in the wellbore fluid density may result leading to a reservoir “kick” or, in the extreme case, a “blowout”—a catastrophic, uncontrolled inflow of reservoir fluids into the wellbore—may occur. A wellbore fluid, if maintained properly, can provide sufficient suspension capacity to counter the settling of solids.

A critical property of wellbore fluids in achieving these functions is viscosity, or the ratio of shearing stress to shearing strain. A wellbore fluid must have sufficient viscosity in order to lift the cuttings to the surface. The rate at which cuttings are removed from the wellbore is a function of the carrying capacity of the wellbore fluid, which depends directly on several factors including the density of the wellbore fluid, viscosity of the wellbore fluid, velocity profile, torque of the drillstring, size and shape of the solid particles, rotation of the drillstring, and the ratio of the specific gravity of solids to the wellbore fluid.

To increase the lifting capacity of the wellbore fluid (to suspend cuttings and weight materials), one may increase the gel strength of the wellbore fluids. To achieve such an increase in gel strength, a variety of methods exist. One method include adding gelling agents such as bentonite (sodium montmorillonite), attapulgite, or sepiolite, purposely to impart rheological properties to water-base fluids. In addition to clays, one may also add a soluble polymer such as xanthan gum, guar gum, carboxymethyl cellulose, hydroxyethyl cellulose, or synthetic polymers to enhance fluid viscosity. Another method is incorporating natural clays encountered during the drilling of argillaceous (clayey) formations into the wellbore fluid.

Frequently, various types of clay are added to a fluid formulation to give viscosity and enhance the rheological properties of the fluid. Clay possesses a structure of silica-alumina lattices, which are arranged in multiple layers, sometimes with other species such as magnesium or calcium incorporated into the lattices. Water molecules enter the lattice structure and bond with active sites, causing the layers to expand or eventually disperse into individual particles. Dispersion of clay increases the surface area which in turns causes the clay-water site to expand, and the clay-water suspension to thicken. Clays are thus often referred to as gelling agents, and are used to impart viscosity, density, sealing, and thixotropic properties to contribute to the stability of the borehole.

Bentonite is the most widely used naturally occurring clay, and has been used as a gelling agent in drilling fluids for many years. Drilling grade bentonite is often produced from sodium montmorillonite containing deposits either from a single source or by blending material from several sources. It may contain additional materials other than montmorillonite and thus vary in color from light-gray to cream to off-white. The American Petroleum Institute (API) has issued international standards to which ground bentonite must comply and are found in API Specification 13A.

It is known in the art that during the drilling process, the states of hydration and dispersion of bentonite or other similar clay materials determines the rheological properties of water-based fluids. The rheological properties of importance are viscosity (apparent, plastic, and effective), gel strength, and yield point, which may be measured a rotational viscometer (rheometer). However, a balance exists between adding a sufficient amount of gelling agent to increase the suspension of the fluid without also increasing the fluid viscosity to such a point that the fluid possesses a reduced pumpability. A further concern with the use of such clay additives in wellbore fluids is the amount of time required for the fluid to yield so that the fluid may have the thixotropic properties necessary to carry or suspend solids therein.

Accordingly, there exists a continuing need for developments in fluid systems having favorable thixotropic properties.

### SUMMARY OF INVENTION

In one aspect, embodiments disclosed herein relate to a wellbore fluid that includes a base fluid; and a sized non-hydratable clay.

In another aspect, embodiments disclosed herein relate to a wellbore fluid that includes an aqueous fluid; a sized attapulgite clay; and a salt of an alkali metal or alkaline earth metal, wherein the wellbore fluid is substantially free of hydrating clays.

In another aspect, embodiments disclosed herein relate to a method of drilling a subterranean well that includes adding a sized non-hydratable clay to a base fluid to form a drilling fluid; and drilling the well with the drilling fluid.

In yet another aspect, embodiments disclosed herein relate to a method for drilling riserless that includes providing a drilling fluid to a drilling assembly for drilling a borehole on a seafloor, the drilling assembly comprising a drill string and a bottomhole assembly, and wherein the drilling fluid comprises: a brine; and a sized non-hydratable clay; and flowing the drilling fluid and cuttings through an annulus formed by the drill string and the borehole into sea water.

Other aspects and advantages of the invention will be apparent from the following description and the appended claims.

### BRIEF DESCRIPTION OF DRAWINGS

FIG. 1 shows yield with time of various attapulgite samples at 30 ppb in seawater.

FIG. 2 shows yield with time of various attapulgite samples at 35 ppb in seawater.

FIG. 3 plots maximum yield obtained for the attapulgite samples as a function of particle size.

FIG. 4 shows the effect of the stator head on yield of EZ Gel at 30 ppb in seawater.

FIG. 5 shows the effect of the stator head on yield of Gel MS at 30 ppb in seawater.

FIG. 6 shows the effect of the stator head on yield of Basco Gel at 30 ppb in seawater.

FIG. 7 shows the effect of the stator head on yield of M-I Salt Gel at 30 ppb in seawater.

### DETAILED DESCRIPTION

In one aspect, embodiments disclosed herein relate to the use of sized clay materials in formulating wellbore fluids, and methods of use thereof. In particular, embodiments disclosed herein relate to the use of sized non-hydratable clays in wellbore fluids.

Conventionally, two types of clays have been used to formulate a water-based wellbore fluid: bentonite and attapulgite. Bentonite, a three-layer aluminum-silicate mineral, is the most widely used clay. However, its ability to hydrate through the bonding of water to its active sites, causing the expansion and dispersion of the clay particles, which in turn leads to the increase in viscosity, is negatively impacted by the presence of dissolved salts in water. Thus, its use is typically considered to be impractical in offshore applications where seawater is more readily available for use as the continuous phase than fresh water.

Attapulgite (or other non-hydratable clays), on the other hand, forms colloids which are stable in high electrolyte solutions such as seawater, and is therefore often preferred in offshore applications (or other applications where supply of fresh water is limited). Attapulgite is a hydrous magnesium aluminosilicate which is approximately spherical as opposed to the layered structure of smectite clays such as bentonite. This structure results in viscosification without hydration. Rather, viscosification of an attapulgite slurry results from shearing that elongates the clay particles into more of a needle or lathe shape, which is how this clay is typically described in the literature. When suspended in liquid, these lathes bunch together into bundles that have a haystack appearance under an electron microscope. This clay does not swell when contacted with water, so its ability to build viscosity depends upon the extent on which the colloid is sheared.

Thus, the wellbore fluids disclosed herein may contain a non-hydratable clay, such as a clay having a needle-like or chain-like structure that results in viscosification through shearing. In various other embodiments, the non-hydratable clay may be selected from at least one of attapulgite and sepiolite clays. While the non-hydratable clays do not substantially swell in either fresh or salt water, they may still operate to thicken salt solutions. This thickening may be attributed to what is believed to be a unique orientation of charged colloidal clay particles in the dispersion medium, and not actual “hydration.”

As the term “non-hydratable” refers to the clay's characteristic lack of swelling (i.e., a measurable volume increase) in the presence of salt water, a given clay's swellability in sea water may be tested by a procedure described in an article by K. Norrish, published as “The swelling of Montmorillonite,” Disc. Faraday Soc. vol. 18, 1954 pp. 120-134. This test involves submersion of the clay for about 2 hours in a solution of deionized water and about 4 percent sodium chloride by weight per volume of the salt solution. Similarly, a given clay's swellability in fresh water may be tested by an analogous procedure in which the sodium chloride is excluded. A “non-hydratable” clay is defined in one embodiment as one that, under this test, swells less than 8 times by volume compared with its dry volume. In another embodiment, a non-hydratable clay exhibits swelling on the order of less than 2 times; less than 0.3 times in another embodiment; and less than 0.2 times in yet another embodiment.

In further embodiments, the drilling fluids disclosed herein may be substantially free of hydrating clays. As used herein, “hydrating clays” is defined as those clays which swell appreciably (i.e., increase their volume by an amount of at least about 8 times) in either fresh water or salt water, and “substantially free” is defined as an amount that does not significantly affect dispersibility. Hydrating clays may include those clays which swell appreciably in contact with fresh water, but not when in contact with salt water, include, for example, clays containing sodium montmorillonite, such as bentonite. As described above, many hydrating clays have a sheet- or plate-like structure, which results in their expansion upon contact with water.

The use of attapulgite (or other non-hydratable clays) is known in the art. For example, such clays are frequently used in place of bentonite as a “spud mud” to drill a top section of an offshore well, when a brine or other salt-containing water is used as the continuous phase of the wellbore fluid to which the clay is added. Further, as described above, the viscosification of such fluid formulations is achieved by shearing of the fluid so that aggregates of the clay particles are dispersed into individual (or smaller bundles) of needle-like particles, which in turn form random lattices capable of trapping water molecules. It is also thought by the present inventors that shearing may also break the edges of the crystal, creating attractive forces at the charges on the resulting broken bonds, which in turn attract water. However, shearing requires considerable time and energy on a rig for the fluid to reach the desired viscosity.

Because mud pump rates (on a rig) are faster than the time required for sufficient levels of shearing, higher concentrations of clay are therefore typically used to ensure the required viscosity is reached. The inventors of the present application, however, have advantageously discovered that attapulgite (or other non-hydratable clays) of smaller particle size than conventional, commercial products may be dispersed more quickly, enabling viscosity (the yield) to be reached faster and with less shearing energy, without significant increases in plastic viscosity. While not being bound by any particular mechanism, it is proposed that when a fluid is sheared, the clay particles are being effectively milled. Thus, it is theorized that by using a source of finer clay particles, the effective milling during the shearing may be reduced (or eliminated) and, the fluid may reach its yield point more quickly. Additionally, by using sized particles that decrease the amount of time for the fluid to yield, the yield point may be reached by shearing at times amounts that are comparable to mud pump rates, thus allowing lower concentrations of clay to be used while obtaining better performance.

Thus, in accordance with embodiments of the present disclosure, the use of sized or micronized non-hydratable clay may be provided in a wellbore fluid formulation. The inventors of the present disclosure took particle size distributions of various samples of conventional attapulgite clay and determined that sources ranged in average size (i.e., d₅₀ of 64 to 161 microns; however, it must be noted that such size determination/selection is not readily a consideration that is made when incorporating attapulgite into a wellbore fluid formulation. As used herein, the term “sized clay” refers to clay aggregates that have been classified by size into a desired d₅₀ range. Unless otherwise noted, all particle size ranges refer to pre-shear values. For example, using classification equipment, a clay source may be classified by size to separate clay agreements that have an average particle size of less than 50 microns prior to their incorporation in a wellbore fluid and being subjected to any shearing. Thus, in various embodiments, a sized non-hydratable clay of the present disclosure may have a d₅₀ less than about 50 microns, less than about 20 microns in another embodiment, and less than about 10 microns in yet another embodiment. One of ordinary skill in the art would appreciate that selection of a particle size distribution (i.e., from a d₅₀ less than 50, 40, 30, 20, 10 micron, for example, or any other d₅₀ value) may depend on factors such as the type (and accuracy) of shear equipment available, clay concentration, mud pump rates, the yield point desired, etc. For example, it was determined by the present inventors that not only could reduced shearing times be achieved through the use of size non-hydratable clays, but that an increased yield point could be achieved through the use of such sized non-hydratable clays. Thus, if a particular yield point is desired, and a particular type of equipment having slightly lower shear rates must be used, a combination of slightly finer clay particles at lower concentrations or slightly larger particles at higher concentrations may be selected therefrom.

Further, one of ordinary skill in the art will appreciate that while a d₅₀<50 or 20 micron size ranges may be desirable for certain formulations, other size ranges (and distributions) may also be used in the fluids and methods of the present disclosure. Thus, examples of alternate size distributions may include non-hydratable clays having a d₁₀<9 microns, d₂₅<26 microns, and d₅₀<64 microns. Other exemplary embodiments may include non-hydratable clay materials having (before shear) a d₉₀ ranging from 24-68 microns, a d₅₀ ranging from 10-30 microns, and a d₁₀, ranging from 3-6 microns. Further, once these particles have been incorporated into a wellbore fluid and subjected to shear, the distribution may narrow. Thus, embodiments of the present disclosure may include non-hydratable clay materials having (after shear) a d₉₀ ranging from 12-24 microns, a d₅₀ ranging from 3.7-12 microns, and a d₁₀ ranging from 0.6-1.4 microns. However, those of ordinary skill in the art will realize that variations in the size of ground clay materials may vary according to the requirements of a certain wellbore fluid and/or drilling operation.

As mentioned above, the use of sized non-hydratable clays may allow for improved yield point properties. Yield point is a measurement of the electro-chemical or attractive forces under flow conditions, which indicates the ability of a wellbore fluid to carry cuttings out of the wellbore, and is thus dependent upon the surface properties of a fluid's solids. These electro-chemical or attractive forces are a result of negative and positive charges located on or near the particle surfaces, which may be generated, for example, during shearing. In accordance with embodiments of the present disclosure, use of sized non-hydratable clays may allow for yield points of at least about 50 lb/100 ft² to be achieved at concentrations of 30 ppb. Further, yield points of at least about 60 lb/100 ft² may be achieved at concentrations of 35 ppb of non-hydratable clays. Moreover, such yield points may be reached with shear times of less than 30 min when using Silverson mixer with a round hole emulsion screen stator head, which has a shear rate of 6,522,000 s⁻¹. Exemplary concentrations may range from 20 ppb to 50 ppb; however, one skilled in the art would appreciate that other concentrations may be used as the selection of concentration may be dependent on the desired yield point for a particular drilling operation.

Further, one skilled in the art would appreciate that drilling fluids are typically classified according to their base material. In a particular embodiment, the non-hydratable clays may be used to viscosify water-based wellbore fluids, in particular brine-based fluids where bentonite and other hydratable clays may be unsatisfactory. However, the present invention is not so limited, rather, it is envisioned that sized non-hydratable clays may also find use in fresh water.

Brines used in embodiments of the present disclosure may include seawater, aqueous solutions wherein the salt concentration is less than that of sea water, or aqueous solutions wherein the salt concentration is greater than that of sea water. The salinity of seawater may range from about 1 percent to about 4.2 percent salt by weight based on total volume of seawater. Salts that may be found in seawater include, but are not limited to, sodium, calcium, aluminum, magnesium, potassium, strontium, and lithium salts of sulfates, phosphates, silicates, chlorides, bromides, carbonates, iodides, chlorates, bromates, formates, nitrates, oxides, and fluorides. Salts that may be incorporated in a given brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

In one embodiment, the drilling fluid may be formulated to have a density range from about 9 to 14 pounds per gallon. The drilling fluid may be initially formulated to have the desired formulation. Alternatively, the drilling fluid may be formed from a concentrated mud, such as a 16 pound per gallon mud, or heavier mud which is then blended with a brine prior to use in the desired formulation. Those having ordinary skill in the art will appreciate that other densities may be used as desired. When blended from a mud and a brine, the mud may optionally contain a salt, such as a salt of an alkali metal or alkaline earth metal. In one embodiment, the drilling fluid may have a pH greater than about 6. In another embodiment, the drilling fluid may have a pH ranging from about 7.5 to 12. The pH of the drilling fluid may be tailored with the addition of acidic or basic additives, as recognized by one skilled in the art. For example, caustic soda and citric acid may be used to increase or decrease the pH of a fluid, respectively.

Further, in addition to water-based fluids, it is also envisioned that the sized non-hydratable clays may be used in oil-based fluids. The oil-based/invert emulsion wellbore fluids may include an oleaginous continuous phase, a non-oleaginous discontinuous phase, and a micronized weighting agent. One of ordinary skill in the art would appreciate that the clays described above may be modified in accordance with the desired application. For example, modifications may include the incorporation of an oil-wetting agent, as known in the art, to render the additives more suitable for use in oil-based fluids.

The oleaginous fluid may be a liquid, more preferably a natural or synthetic oil, and more preferably the oleaginous fluid is selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids; similar compounds known to one of skill in the art; and mixtures thereof. The concentration of the oleaginous fluid should be sufficient so that an invert emulsion forms and may be less than about 99% by volume of the invert emulsion. In one embodiment, the amount of oleaginous fluid is from about 30% to about 95% by volume and more preferably about 40% to about 90% by volume of the invert emulsion fluid. The oleaginous fluid, in one embodiment, may include at least 5% by volume of a material selected from the group including esters, ethers, acetals, dialkylcarbonates, hydrocarbons, and combinations thereof.

The non-oleaginous fluid used in the formulation of the invert emulsion fluid disclosed herein is a liquid and may be an aqueous liquid. In one embodiment, the non-oleaginous liquid may be selected from the group including sea water, a brine containing organic and/or inorganic dissolved salts, liquids containing water-miscible organic compounds, and combinations thereof. The amount of the non-oleaginous fluid is typically less than the theoretical limit needed for forming an invert emulsion. Thus, in one embodiment, the amount of non-oleaginous fluid is less that about 70% by volume, and preferably from about 1% to about 70% by volume. In another embodiment, the non-oleaginous fluid is preferably from about 5% to about 60% by volume of the invert emulsion fluid. The fluid phase may include either an aqueous fluid or an oleaginous fluid, or mixtures thereof. In a particular embodiment, coated barite or other micronized weighting agents may be included in a wellbore fluid having an aqueous fluid that includes at least one of fresh water, sea water, brine, and combinations thereof

Conventional methods can be used to prepare the drilling fluids disclosed herein in a manner analogous to those normally used, to prepare conventional water- and oil-based wellbore fluids. In one embodiment, a desired quantity of water-based fluid and a suitable amount of a sized non-hydratable clay, as described above, are mixed together and any remaining components of the wellbore fluid added sequentially with continuous mixing. In another embodiment, a desired quantity of oleaginous fluid such as a base oil, a non-oleaginous fluid, and a suitable amount of a sized non-hydratable clay (optionally modified) are mixed together and any remaining components are added sequentially with continuous mixing. An invert emulsion may be formed by vigorously agitating, mixing, or shearing the oleaginous fluid and the non-oleaginous fluid.

Other additives that may be included in the wellbore fluids disclosed herein include, for example, wetting agents, organophilic clays, viscosifiers, fluid loss control agents, surfactants, dispersants, interfacial tension reducers, pH buffers, mutual solvents, thinners, thinning agents, and cleaning agents. The addition of such agents should be well known to one of ordinary skill in the art of formulating drilling fluids and muds.

Further, as mentioned above, the fluids of the present disclosure may find particular use as a “spud mud,” a water-based mud used to drill a well from the surface to a shallow depth. In such cases, the drilling is often performed riserless, whereby upon flowing through the bit, the fluid flows through an annulus between the drill string and the borehole into the seawater. Further discussion of riserless drilling may be found in U.S. Patent Publication No. 2007/0246221, which is assigned to the present assignee and herein incorporated by reference in its entirety. However, the present disclosure is not so limited. Rather, the sized non-hydratable clays may be used in any fluid where clays are conventionally used and/or where viscosification is desired, or in drilling any other well sections

### EXAMPLES

The following examples were used to test the effectiveness of the drilling fluids disclosed herein in the ability and efficiency to achieve yield point.

Six samples of clay from Zemex Industrial Materials (Atlanta, Ga.) or M-I LLC (Houston, Tex.) of milled Attapulgite clay of various grades were tested. The particle size distribution for each sample is given in Table 1.

TABLE 1

| | Particle sizes, micrometer | | | | | | | | |
|---|---|---|---|---|---|---|---|---|---|
| Clay Name | d10 | d25 | d50 | d75 | d90 | Mean | Median | Mode | Std. dev. |
| Zemex Gel 701-P | 3.517 | 5.786 | 9.966 | 16.25 | 23.79 | 9.486 | 9.966 | 11.29 | 2.069 |
| Zemex Gel MS | 5.640 | 12.86 | 29.65 | 49.98 | 68.25 | 23.48 | 29.65 | 50.22 | 2.699 |
| Zemex EZ Gel | 5.195 | 11.22 | 24.82 | 42.85 | 60.65 | 20.47 | 24.82 | 41.68 | 2.660 |
| M-I Salt Gel | 9.165 | 26.66 | 64.25 | 130.20 | 207.40 | 52.10 | 64.25 | 116.30 | 3.411 |
| Zemex Gel Sorb | 14.630 | 72.37 | 161.3 | 320.20 | 506.50 | 121.90 | 161.30 | 295.50 | 4.002 |
| Zemex Basco Salt Mud | 7.585 | 20.47 | 56.87 | 115.90 | 190.20 | 44.98 | 56.87 | 96.49 | 3.593 |

For all testing, the various grades of clay were slurried in synthetic seawater, with no other materials added to the slurries. The synthetic seawater was formulated in the lab with 4.046 weight percent sea salt (supplied by Lake Chemical Products and contains various minerals such as calcium and magnesium salts in addition to the predominant sodium chloride) in deionized water. Before subjecting to shear, the dry clay was homogenized briefly in the salt water using an ordinary laboratory overhead mixer.

Effect of Concentration and Particle Size on Yield

The clay samples were added at 30 ppb, 35 ppb and 40 ppb (equivalent to g/350 mL) to seawater and sheared for up to 2 hours or until a yield point of 60 lb/100 ft² was reached. Samples were taken throughout the mixing time and the viscosity measured using a Farm 35 viscometer at 120° F. The results are shown in FIGS. 1-3.

FIG. 1 shows the yield point of the attapulgite samples as a function of time at 30 ppb. Specifically, a relationship between particle size of the clay sample and the yield may be observed. The sample with the largest median particle size, Gel Sorb, showed yield very much lower than all other samples tested. Even at concentrations up to 50 ppb (not shown), this material did not yield above 40 lb/100 ft². Gel 701-P which has the lowest median particle size of 9.966 μm yielded quickly and achieved 60 lb/100 ft² within 1 hour of shearing. Gel Sorb was eliminated from further testing due to its low yield at 30 ppb and the superior performance of the other products.

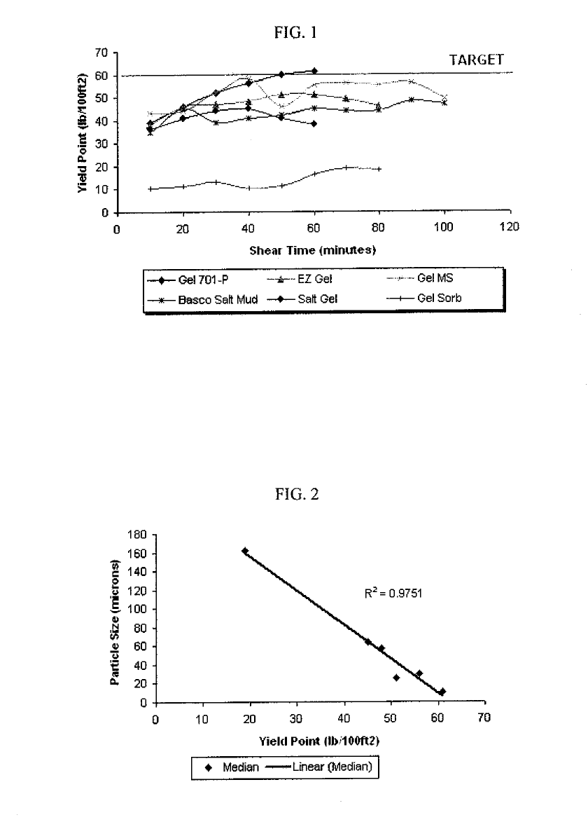

Testing was repeated with all other samples repeated at the higher concentration of 35 ppb in seawater, the results of which are shown in FIG. 2. All samples reached 60 lb/100 ft² and most within 40 minutes; however, Gel 701P, EZ Gel, and Gel MS all achieved 60 lb/100 ft² within 30 min. Final maximum yield point was not determined in this test so final viscosity as a function of particle size was not be determined (as it was for 30 ppb discussed below). The experiment was designed to show that the target yield could be reached by increasing product concentration.

It was noted in these tests that some clay samples exhibit a “viscosity hump” where a maximum yield point is reached and then further shearing causes a decrease in yield point. The traditional view of attapulgite is that the material possesses long, thin needle-like shape. When the clay is sheared and charges are then exposed, the clay particles are attracted end-to-end, in a long string-like fashion, which results in an increase in viscosity. However, after a certain amount of time, the shearing becomes destructive and the end-to-end links become compromised, which is manifested through a subsequent decrease in viscosity.

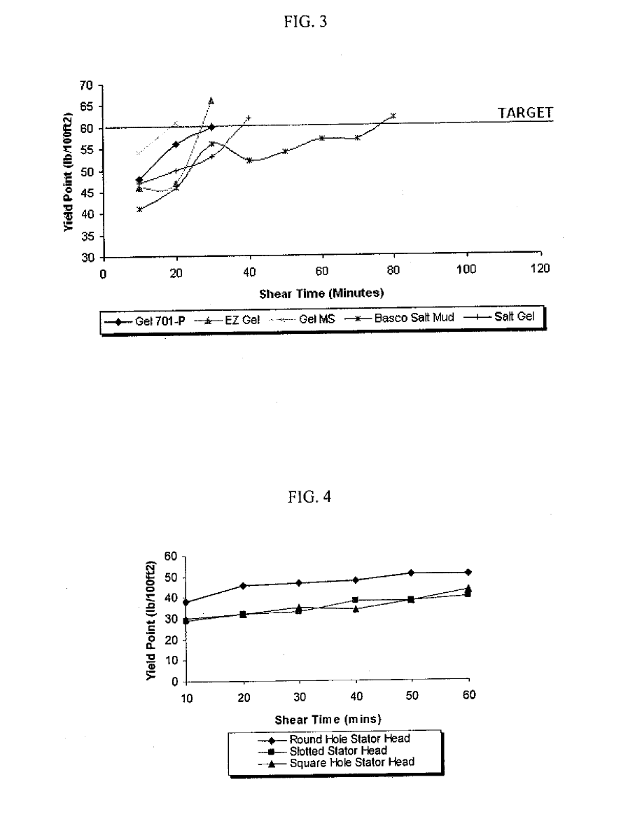

FIG. 3 shows the maximum yield point achieved (for 30 ppb) plotted against median particle size. It can be seen that a linear relationship, with good correlation exists, with the smaller particle size giving the highest viscosity.

Effect of Shear

EZ Gel, Gel MS, Basco Salt Mud, and Salt Gel slurries at 30 ppb in seawater were prepared and sheared with different stator heads on the Silverson mixer. The viscosity was measured over time with a Fann 35 viscometer. The three different stator heads were used: a Round Hole Emulsor Screen, a Square Hole High Shear Screen and a Slotted Hole High Shear Screen. The shear rate for each type of stator head was calculated, with an impeller velocity of 6000 rpm, to be Round Hole Emulsor Screen, 6,522,000 s⁻¹, Square Hole High Shear Screen, 2,304,000 s⁻¹, and Slotted Hole High Shear Screen, 384,000 s⁻¹. The inside diameter of each stator head was measured to be 32mm, suggesting that the gap shear rate would be identical for each stator head for a given impeller rate and the same type of impeller. No alternate configurations of impellers were available during the project. At 6000 rpm, the tip speed of the impeller is 565.5 m/s, and the gap shear rate for each stator head is 282,744 s¹.

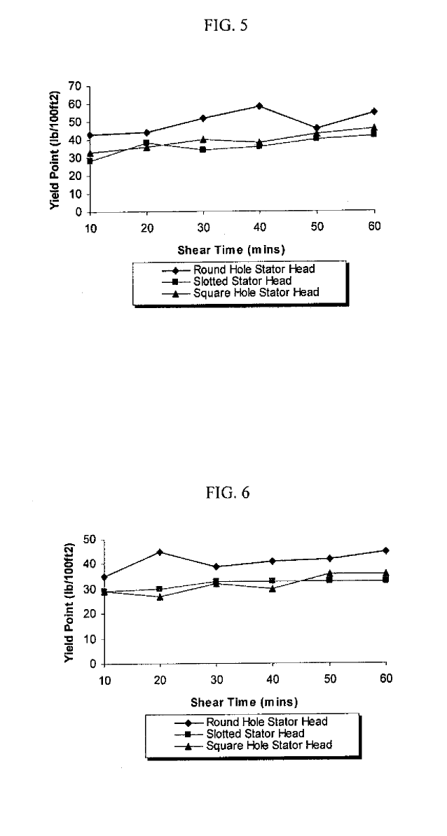

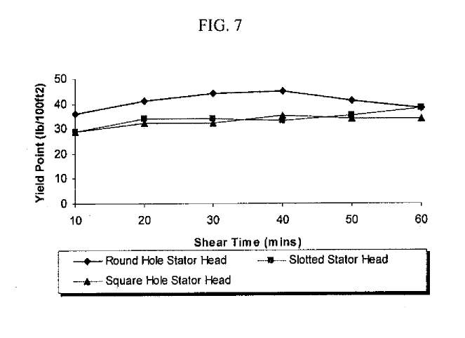

The initial particle size distribution of each of the grades of clay (shown in Table 1 and determined as supplied from the vendor) is compared to the particle size distribution retested after shearing, the results of which are shown in Table 2 below. The results of the effect of the different stators (and thus shear rates) on the yield for each of the samples are shown in FIGS. 4-7.

For each sample, testing to determine viscosity generation from shear with various Silverson stator heads shows that the Round Hole Emulsor Screen produced a faster rate of yield than the other two stator heads, which is illustrated in FIGS. 4-7. This is as expected, showing that increasing surface area, smaller shear holes and therefore greater shear force (and rate) allows the particles to break up and become hydrated more efficiently, generating higher viscosity. The round-hole emulsor head gives the highest shear rate correlating to the fastest product yield.

TABLE 2

| | Particle sizes, micrometers | | | | | | | | |
|---|---|---|---|---|---|---|---|---|---|
| | Before/ | | | | | | | | |
| | After | | | | | | | | |
| Clay Name | Shear | d10 | d25 | d50 | d75 | d90 | Mean | Median | Mode |
| Gel 701-P | Before | 3.517 | 5.786 | 9.966 | 16.25 | 23.79 | 9.486 | 9.966 | 11.29 |
| | After | 1.389 | 3.140 | 6.449 | 11.75 | 18.52 | 5.583 | 6.449 | 8.536 |
| EZ Gel | Before | 5.195 | 11.22 | 24.82 | 42.85 | 60.65 | 20.47 | 24.82 | 41.68 |
| | After | 0.658 | 1.602 | 4.615 | 10.65 | 19.65 | 3.932 | 4.615 | 10.29 |
| Gel MS | Before | 5.640 | 12.86 | 29.65 | 49.98 | 68.25 | 23.48 | 29.65 | 50.22 |
| | After | 0.848 | 2.185 | 5.197 | 11.30 | 23.92 | 4.831 | 5.197 | 5.878 |
| M-I Salt Gel | Before | 9.165 | 26.66 | 64.25 | 130.20 | 207.40 | 52.10 | 64.25 | 116.30 |
| | After | 0.707 | 1.718 | 3.753 | 7.20 | 12.13 | 3.269 | 3.753 | 4.877 |
| Gel Sorb | Before | 14.630 | 72.37 | 161.3 | 320.20 | 506.50 | 121.90 | 161.30 | 295.50 |
| | After | 1.001 | 2.934 | 11.74 | 26.51 | 63.36 | 8.976 | 11.74 | 16.40 |
| Basco Salt | Before | 7.585 | 20.47 | 56.87 | 115.90 | 190.20 | 44.98 | 56.87 | 96.49 |
| Mud | After | 0.671 | 1.538 | 4.262 | 10.53 | 19.53 | 3.865 | 4.262 | 11.29 |

Determination of the particle size of the clay samples in the dry state and then after shearing and hydration has shown that the PSD shifts to the left indicating a decrease in the amount of coarse particles and an increase in the concentration of finer particles. This shift suggests that the clay particles are breaking apart in a wet-milling process. The milling process is more evident in samples with coarser particles and suggests that if finer grade material is used, the requirement for wet milling is reduced and the amount of shear required to achieve viscosity will be reduced. A plot of the data in Table 2 would show that the shift for M-I Salt Gel is much greater as compared to the initially finer product, Gel 701-P.

Advantageously, embodiments of the present disclosure for at least one of the following. Use of non-hydratable clays of smaller particle size than conventional, commercial products may be dispersed more quickly, enabling viscosity (the yield) to be reached faster and with less shearing energy. Additionally, by using sized particles that decrease the amount of time for the fluid to yield, the yield point may be reached by shearing in time amounts that are comparable to mud pump rates, thus allowing lower concentrations of clay to be used while obtaining better performance. Further, not only may reduced shearing times be achieved through the use of size non-hydratable clays, but an increased yield point may be achieved through the use of such sized non-hydratable clays. Such yield points may be obtained at lower concentrations, allowing for a cost savings, particularly when drilling riserless (as the fluid is not returned to the surface and reclaimed). Additionally, when fluids are not pre-sheared (at all or completely) and shearing is achieved through the pumping process, the quantities of clay required may still be reduced as compared to use of conventional clay due to the shorter yield times.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A wellbore fluid, comprising:
a base fluid; and
a sized non-hydratable clay.

2. The fluid of claim 1, wherein the non-hydratable clay comprises at least one of attapulgite and sepiolite clays.

3. The fluid of claim 1, wherein the non-hydratable clay comprises a d₅₀ of less than about 20 microns.

4. The fluid of claim 1, wherein the non-hydratable clay comprises a d₅₀ ranging from 10 to 30 microns.

5. The fluid of claim 1, wherein the non-hydratable clay is present in an amount ranging from 20 to 50 ppb.

6. The fluid of claim 1, wherein the base fluid is an aqueous fluid comprising a salt of an alkali metal or alkaline earth metal.

7. The fluid of claim 1, further comprising:
at least one of a weighting agent, a deflocculant, a fluid loss control agent, and combinations thereof.

8. The fluid of claim 1, wherein the base fluid is an oleaginous based fluid.

9. A wellbore fluid, comprising:
an aqueous fluid;
a sized attapulgite clay; and
a salt of an alkali metal or alkaline earth metal, wherein the wellbore fluid is substantially free of hydrating clays.

10. The fluid of claim 9, wherein the non-hydratable clay comprises a d₅₀ of less than about 20 microns.

11. The fluid of claim 10, wherein the non-hydratable clay comprises a d₅₀ ranging from 6 to 12 microns.

12. The fluid of claim 9, wherein the non-hydratable clay is present in an amount ranging from 20 to 50 ppb.

13. A method of drilling a subterranean well, comprising:
adding a sized non-hydratable clay to a base fluid to form a drilling fluid; and
drilling the well with the drilling fluid.

14. The method of claim 13, wherein the non-hydratable clay comprises at least one of attapulgite and sepiolite clays.

15. The method of claim 13, wherein the non-hydratable clay comprises a d₅₀ of less than about 20 microns.

16. The method of claim 13, wherein the non-hydratable clay comprises a d₅₀ ranging from 10 to 30 microns.

17. The method of claim 13, wherein the non-hydratable clay is present in an amount ranging from 20 to 50 ppb.

18. The method of claim 13, wherein the base fluid is an aqueous fluid comprising a salt of an alkali metal or alkaline earth metal.

19. A method for drilling riserless, comprising:
providing a drilling fluid to a drilling assembly for drilling a borehole on a seafloor, the drilling assembly comprising a drill string and a bottomhole assembly, and wherein the drilling fluid comprises:
a brine; and
a sized non-hydratable clay; and
flowing the drilling fluid and cuttings through an annulus formed by the drill string and the borehole into sea water.

20. The method of claim 19, wherein the non-hydratable clay comprises at least one of attapulgite and sepiolite clays.

21. The method of claim 19, wherein the non-hydratable clay comprises a d₅₀ of less than about 20 microns.

22. The method of claim 19, wherein the non-hydratable clay comprises a d₅₀ ranging from 10 to 30 microns.

23. The method of claim 19, wherein the non-hydratable clay is present in an amount ranging from 20 to 50 ppb.
